(19) United States
(12) Patent Application Publication
(10) Pub. No.: US 2010/0320842 A1
(43) Pub. Date: Dec. 23, 2010

(54) STARTUP SOURCE INVERTER

(75) Inventor: Bernhard Beck, Volkach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Adensis GmbH, Dresden (DE)

(21) Appl. No.: 12/818,305

(22) Filed: Jun. 18, 2010

(30) Foreign Application Priority Data
Jun. 18, 2009 (DE) 10 2009 025 363.7

(51) Int. Cl. H02J 3/08

(52) U.S. Cl. 307/80

(57) ABSTRACT

A method and an apparatus for setting up synchronization, with a power grid, of an inverter having a photovoltaic generator as a primary energy source is disclosed. The inverter is supplied with the energy from an additional energy source connected in parallel with input terminals of the inverter, wherein the additional energy source is a DC energy source operated independent from the primary energy source. The frequency, phase relationship and output voltage of the inverter supplied from the additional DC energy source are matched to the frequency, phase relationship and output voltage of the power grid, whereafter the primary energy source is connected to the inverter. With this method, an inverter dimensioned for a permissible open-circuit voltage can also be used under operating conditions, without requiring modifications of the circuitry of the primary energy source.

### CROSS-REFERENCES TO RELATED APPLICATIONS

This application claims the priority of German Patent Application, Serial No. 10 2009 025 363.7, filed Jun. 18, 2009, pursuant to 35 U.S.C. 119(a)-(d), the content of which is incorporated herein by reference in its entirety as if fully set forth herein.

### BACKGROUND OF THE INVENTION

The present invention relates to a method for preparing synchronization to a power grid of an inverter having a photovoltaic generator as primary energy source (Q1), wherein the inverter can be connected to power grid. The application is also directed to an apparatus for carrying out the method.

The following discussion of related art is provided to assist the reader in understanding the advantages of the invention, and is not to be construed as an admission that this related art is prior art to this invention.

Such method is suitable to supply the AC current produced by the inverter in a photovoltaic system into the power grid, preferably a public power grid. Photovoltaic systems are known wherein the DC current supplied by the photovoltaic modules is converted with an electrical converter or inverter into AC current which is then supplied to the power grid. Presently, electrical inverters commercially available for large facilities are designed for a power output of up to 700 kW and are, of course, correspondingly expensive. System having a larger power output must use several electrical inverters. For example, a solar system with power rating of 2.5 MW presently uses at least nine electrical inverters, with each of the inverters being rated for a power output of 330 kW. For systems installed on roofs and for smaller outdoor systems, correspondingly smaller inverters are available in almost all required sizes ranging from several kW up to several hundred kW.

Photovoltaic systems are well known. They are typically constructed by connecting a plurality of branches in parallel. The maximum number of branches is determined by the rating of the inverter to which the branches are connected. Modern inverters can be designed for an input DC voltage of up to 900 V.

It is presently customary to construct each branch from eight to photovoltaic modules, each having 60 photovoltaic cells. Altogether, 480 cells are then connected in series. Each cell has an open-circuit voltage of 1.5 V, which results in a branch voltage of 720 V, which is significantly below the maximal voltage of 1000 V stated by the manufacturers of the modules. If a higher voltage is applied, the modules and the entire facility, including the inverters, may be destroyed.

During operation of the system, the open-circuit voltage of the cells decreases to an operating voltage of about 1 to 1.1 V, so that a voltage of 480 V and 510 V is applied between the end points of the conventional branches. To simplify the discussion, an operating voltage of 1 V per cell will be assumed, i.e., a voltage of 60 V across a single photovoltaic module with 60 cells. If the power grid operator to which the photovoltaic system is connected, disconnects the photovoltaic system from the power grid, (e.g., short circuit in the feeder cable) then the voltage jumps to the aforementioned 720 V, which is not critical for the modules and the system.

On the other hand, it would be desirable to operate the photovoltaic modules and hence also the inverter in normal operation with a higher voltage than 480-510 V, ideally with the maximum allowable voltage of 1000 V. However, this is not possible because the open-circuit voltage of about 1500 V would then result in destruction of the photovoltaic modules, the inverter and the entire facility.

Rating the inverters for the maximal allowable voltage limit of presently about 1000 V ensues substantial technical complexity relating to the dielectric strength of the employed components, for example the capacitors, as well as current-carrying capacity, for example insulation and cross-section of the conductors of the cable. This technical complexity is caused only by the high open-circuit voltage. The inverter could also be operated at the 1000 V under load, whereby the inverter would then be disconnected from the photovoltaic system in the event of a fault causing an overvoltage above the limit value of, for example, 1000 V. The problem here is, however, that once disconnected from the power grid, the photovoltaic system can not be reconnected again to the power grid, if the voltage at its output terminals has an open-circuit voltage far above 1000 V, e.g., the aforementioned 1500 V. However, this is always the case when the PV system is operated at its most effective times.

It would therefore be desirable and advantageous to obviate prior art shortcomings and to provide an improved method and apparatus for connecting an inverter to power grid, even if the open-circuit DC voltage supplied by the photovoltaic system far exceeds the permissible operating voltage of the inverter.

### SUMMARY OF THE INVENTION

According to one aspect of the present invention, a method for setting up synchronization, with a power grid, of an inverter having a photovoltaic generator as a primary energy source, includes supplying the inverter with the energy from an additional energy source connected in parallel with input terminals of the inverter, wherein the additional energy source is a DC energy source operated independent from the primary energy source, adapting frequency, phase relationship and output voltage of the inverter supplied from the additional DC energy source to frequency, phase relationship and output voltage of the power grid, and after adaptation, connecting the primary energy source to the inverter.

According to another aspect of the invention, an apparatus for setting up synchronization, with a power grid, of an inverter having a photovoltaic generator as a primary energy source by carrying out the aforementioned method includes a plurality of photovoltaic modules representing a primary energy source, an inverter having input terminals and output terminals, the input terminals connected to the plurality of photovoltaic modules supplying a DC input voltage and a DC input current to the input terminals, an additional DC current source configured for parallel connection with the input terminals of the inverter, a control device which controls with the additional DC current source an output voltage at the output terminals of the inverter, until frequency, phase relationship and voltage of the power grid is present at the output terminals of the inverter, and a switch configured to connect the output terminals of the inverter to the power grid.

Advantageously, the second energy or current source, which is preferably a DC power supply, is designed for a voltage in a voltage range between 300 and 600 V. Several output voltages or an adjustable output voltage, as is customary with power supplies, may be provided. The voltage required as a startup or switch-on aid depends on the employed inverter and its control device for setting the maximal power point (abbreviated as MPP control device). If the voltage provided to the control device by the PV system is too small, for example below a minimum voltage of about 300 V, then the control device is unable to provide control. Conversely, if the voltage is too high, i.e., above the permissible operating voltage, then the control device may be destroyed. The second voltage source is designed for a value below this range. The second voltage source must be capable of supplying a minimum power in a range from one kW to several hundred kW depending on the size of the employed inverter. Once the inverter is connected to the power grid, the PV system can be connected to the input of the inverter. The high open-circuit voltage of, e.g. 1500 V, then collapses to the operating voltage of 1000 V, which does not endanger the inverter.

To prevent high compensating currents between the PV system and the second energy source when the PV system is switched in, either a blocking diode is provided, or the operation is set up so that the second energy source is disconnected from the inverter immediately before the PV system is connected to the inverter. The open-circuit voltage of the PV system of, for example, the aforementioned 1500 V collapses within microseconds to the operating voltage of 1000 V which does not harm the inverter and does not cause damage. The inverter components are so slow that the attained adaptation to the power grid characteristic is maintained during the switch-over (first disconnecting the second energy source, then connecting the first energy source). This switch-over may be performed with a switch, wherein the two switching operations occur sequentially within a timeframe of only several microseconds: first disconnection of the second energy source from the inverter, then connection of the first energy source=PV system to the inverter.

Advantageously, the second energy source is disconnected from the inverter after the photovoltaic system is connected to the power grid, to prevent aging of the inverter. If this aspect is not important, then the second energy source may remain permanently connected to the inverter at least during daytime by interconnecting a blocking diode. In this case, power is supplied from the second energy source to the inverter only when the output voltage of the PV system is lower than the output voltage of the second energy source.

After the frequency, the voltage and the phase relationship of the inverter has been adapted to the frequency, voltage and phase relationship of the power grid, the electrical output terminals of the converter are connected to the power grid, after disconnection of the second energy source from the inverter. The second energy source is then on standby for renewed synchronizing.

The switching element used for the switch-over may be a double switch, which connects the photovoltaic system as primary DC source to the inverter at the same time the second DC current source is disconnected from the inverter.

The second energy source is supplied from the power grid, in particular if the second energy source is connected to the inverter permanently or over a longer time period. Because connection of the photovoltaic generator under full load of the PV system is relatively rare, the second energy source may also be an electric energy storage device, such as a conventional lead battery.

Advantageously, an additional switching element may be provided between the inverter and the power grid which, when actuated, connects the inverter to the power grid and disconnects the second energy source from the power grid. The power output of the second energy source may be less than 10% of the rated power of the inverter, in particular less than 1%. This value depends on the size of the PV generator to be started up, or the size of the inverter to which this PV generator is connected, optionally with other PV generators.

It is not necessary to connect the complete PV generator, if it is composed of several independently operating PV generators, to the inverter and the power grid in a single operation. Depending on the situation at the site, in particular the number of employed inverters and the size of the PV system, it may be advantageous to connect only a portion of the photovoltaic system to the inverter after frequency adaptation and phase relationship adaptation has been completed. In this case, an inverter which is supplied from the photovoltaic generator that did not need to be disconnected from the power grid may operate as the second energy source.

The second energy source is preferably housed in the housing of the inverter.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a schematic block diagram of a photovoltaic system with a second energy source;

FIG. 2 a schematic block diagram of a photovoltaic system with a battery as the second energy source; and

FIG. 3 a schematic block diagram of a photovoltaic system with a photovoltaic generator that remains connected to the power grid as the second energy source.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

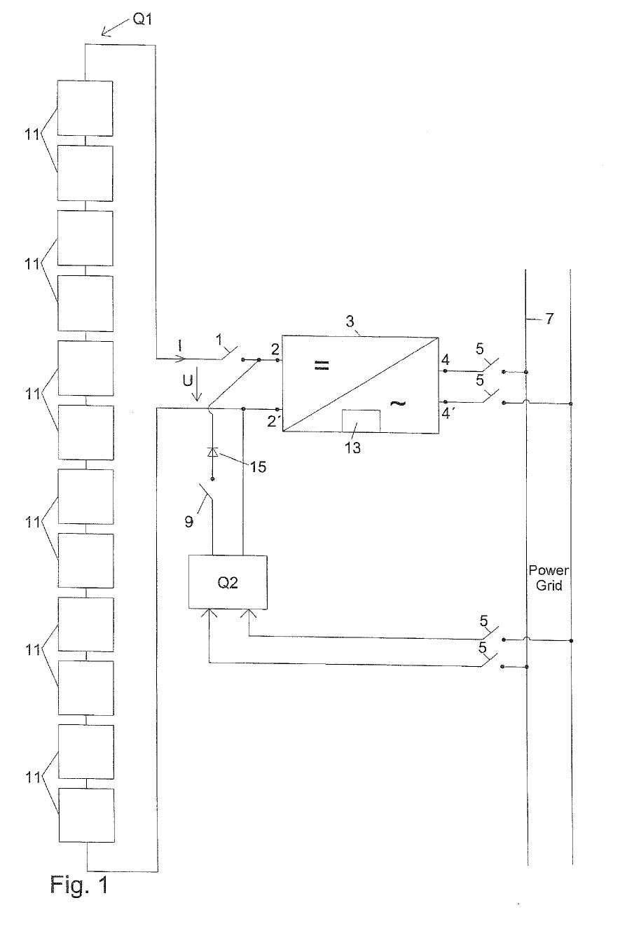

Turning now to the drawing, and in particular to FIG. 1, there is shown schematically a photovoltaic generator as a first energy source or primary energy source Q1. The photovoltaic generator Q1 is connected to the input terminals 2, 2′ of an inverter 3 via a first switch 1. The output contacts 4, 4′ of the inverter 3 can be connected via a switching element 5 to a public power grid 7, of which only two phases are shown. The basic design up to this point is conventional. As already mentioned at the beginning of the specification, all components of the inverter 3 must be rated for the open-circuit voltage of the PV generator Q1, which may be, for example, 720 V at noontime during summer months. The voltage in operation is then about 450 V. If the PV generator Q1 is switched off in this situation for any reason whatsoever, then the PV generator Q1 may safely be reconnected to the inverter 3, because a substantial safety margin still exists between the 720 V open-circuit voltage and the maximum allowable voltage of 1000 V.

With the help of a second energy source Q2, the configuration of the inverter 3 and/or the primary energy source Q1 can be changed so as to better utilize the existing components, or to connect a larger PV system Q1 to the existing inverter 3. The second energy source Q2 is connected via a switching device 9 to the input terminals 2, 2′ of the inverter 3, to which the PV generator Q1 is also connected. The PV generator Q1 now has a larger number of serially connected PV modules 11 than would currently be feasible without the benefit of the present invention. For example, an arrangement with twelve modules 11 instead of the aforementioned eight modules 11 is possible, resulting in an operating voltage of 12 times 60 V during operation, assuming one Volt per cell and 60 cells per module 11, for a total of 720 V. An operating voltage of 720 V in a conventional configuration results in an open-circuit voltage of 1.5 times 720 V, which is equal to 1080 V. If the PV generator Q1 is then disconnected from the power grid 7, wherein the switching element 5 is now open, then the PV generator Q1 can no longer be reconnected to the power grid 7, preventing power to be supplied for the rest of the day.

The situation is different when the second energy source Q2 is used. The disconnected photovoltaic generator Q1 is disconnected from the inverter 3 when the first switch 1 is open and is hence not considered in the connection process. The second energy source Q2 is connected to the inverter 3 by closing the switching device 9. The inverter 3 uses the second energy source Q2 to initiate synchronization with the power grid 7 by way of a control device 13 disposed in the inverter 3. After synchronization is completed, i.e., the conditions in the power grid 7 are adapted so that the phase relationship, the frequency and the voltage are identical to those in the power grid 7, the switching element 5 is closed and the inverter 3 is reconnected to the power grid 7.

Two scenarios which will be described below are possible for connecting the primary source Q1 to the inverter 3:
The second energy source Q2 is disconnected from the inverter 3 by opening the switching device 9, and the first switch 1 is immediately closed thereafter within microseconds, before synchronization is lost, or
The first energy source Q1 is connected in parallel with the second energy source Q2 to the input terminals 2, 2′ of the inverter 3 by closing the first switch 1 after synchronization has been completed, and the switching device 9 is subsequently opened.

A blocking diode 15 may be arranged between the switching device 9 and the input terminals 2, 2′ of the inverter 3 to prevent current from flowing into the second energy source Q2, if the second energy source Q2 has a higher voltage when the primary energy source Q1 is connected. If the blocking diode 15 has sufficient dielectric strength, then the second energy source Q2 may, if desired, remain connected with the inverter 3 even for a longer time, thus permanently maintaining the synchronization state.

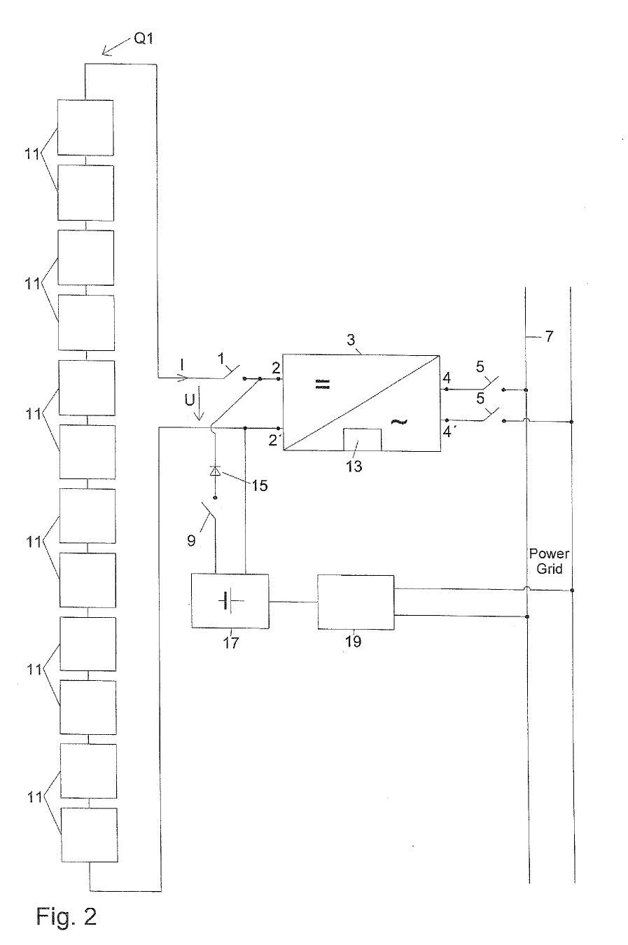

FIG. 2 shows as the second energy source Q2 a battery 17 which may be charged by power supply 19 connected to the power grid 7. With adequately dimensioned capacity, the power supply can be omitted, because the battery may also be charged by the primary energy source Q1.

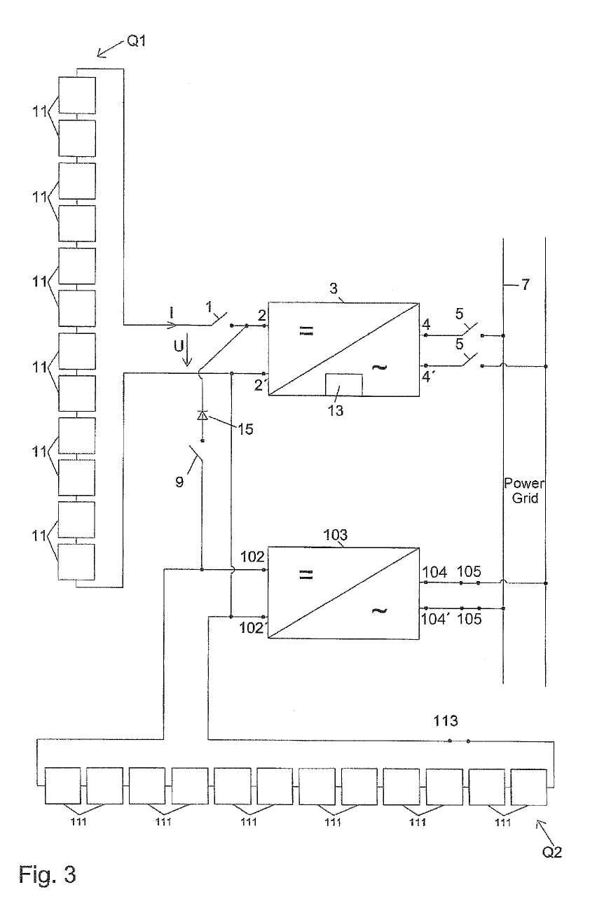

FIG. 3 shows another variant of the secondary energy source Q2. A large solar installation may include several PV generators, of which another PV generator, which may exist in addition to the primary source Q1, is symbolically indicated in FIG. 3 by its PV modules 111. The additional PV generator 111 needed not be disconnected from the power grid 7 like the primary source Q1, but remained connected to the power grid 7, when an additional switching element 105 is closed, and supplies the generated solar energy without interruption to the power grid 7 via the inverter 103 connected to the additional PV generator 111. In this way, the additional PV generator 111 can be used as the second energy source Q2 according to the present invention. The startup process is analogous to the startup process described with reference to FIG. 1 above: with the first switch 1 open, the switching device 9 is closed, so that the input terminals 102, 102′ of the additional inverter 103 are connected in parallel with the input terminals 2, 2′ of the inverter 3. A startup source Q2 is here also provided independent of the first PV generator Q1.

The secondary energy source Q2 has an additional switch 113 which can be used to disconnect the PV modules 111 from the inverter 103 if the system voltage of the PV modules 111 is too low, and to start up the primary source Q1 with the inverter 103 associated with the secondary energy source Q2 from the power grid.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed is:

1. A method for setting up synchronization, with a power grid, of an inverter having a photovoltaic generator as a primary energy source, comprising the steps of:
supplying the inverter with the energy from an additional energy source connected in parallel with input terminals of the inverter, wherein the additional energy source is a DC energy source operated independent from the primary energy source,
adapting frequency, phase relationship and output voltage of the inverter supplied from the additional DC energy source to frequency, phase relationship and output voltage of the power grid, and
after adaptation, connecting the primary energy source to the inverter.

2. The method of claim 1, further comprising the step of disconnecting the additional DC energy source from the inverter after the adaptation and before connecting the primary energy source to the inverter.

3. The method of claim 1, wherein the additional DC energy source is permanently connected to the inverter by an intermediate blocking diode.

4. The method of claim 2, wherein after the adaptation of the frequency and phase relationship of the inverter, connecting electrical output terminals of the inverter to the power grid, before the additional DC energy source is disconnected from the inverter.

5. The method of claim 2, wherein the additional DC energy source is connected to the input terminals of the inverter via a switching device.

6. The method of claim 5, wherein the switching device connects the photovoltaic generator as primary energy source to the inverter at the same time the additional DC current source is disconnected from the inverter.

7. The method of claim 1, wherein the additional DC energy source is supplied with electric power from the power grid.

8. The method of claim 1, wherein the additional DC energy source is an electric energy storage device.

9. The method of claim 7, further comprising the steps of:
connecting the inverter to the power grid by actuating a switching element interconnected between the inverter and the power grid, and
disconnecting the additional DC energy source from the power grid by way of auxiliary contacts.

10. The method of claim 1, wherein power supplied by the additional DC energy source is less than 10% of a nominal power of the inverter.

11. The method of claim 1, wherein for a photovoltaic generator having an output power rating of greater than 100 kW, power supplied by the additional DC energy source is less than 1% of a nominal power of the inverter.

12. The method of claim 1, characterized in that the additional DC energy source is a second inverter of a second photovoltaic generator, which is not disconnected from the power grid and which continues to operate.

13. An apparatus for setting up synchronization, with a power grid, of an inverter having a photovoltaic generator as a primary energy source, the apparatus comprising:
a plurality of photovoltaic modules representing a primary energy source, an inverter having input terminals and output terminals, the input terminals connected to the plurality of photovoltaic modules supplying a DC input voltage and a DC input current to the input terminals,
an additional DC current source configured for parallel connection with the input terminals of the inverter,
a control device which controls with the additional DC current source an output voltage at the output terminals of the inverter, until frequency, phase relationship and voltage of the power grid is present at the output terminals of the inverter, and
a switch configured to connect the output terminals of the inverter to the power grid.

14. The apparatus of claim 13, wherein the additional DC energy source is operable independent of the primary energy source and provides a DC voltage between 300 V and 800 V.

15. Apparatus according to claim 13, characterized in that the additional DC energy source is housed in a housing of the inverter.
